(19) United States
(12) Patent Application Publication
(10) Pub. No.: US 2016/0319615 A1
(43) Pub. Date: Nov. 3, 2016

(54) DIRECT DRIVE VERTICAL CUTTINGS DRYER AND METHODS OF MAKING AND USING, AND RETROFITTING CUTTINGS DRYERS

(71) Applicant: KEMTRON TECHNOLOGIES, LLC, STAFFORD, TX (US)

(72) Inventors: EMAD BABRI, Katy, TX (US); Michael R. Anderson, Houston, TX (US)

(73) Assignee: KEMTRON TECHNOLOGIES, LLC, STAFFORD, TX (US)

(21) Appl. No.: 14/702,757

(22) Filed: May 3, 2015

(51) Int. Cl. E21B 21/06; F26B 5/08

(52) U.S. Cl. CPC E21B 21/06; F26B 5/08

(57) ABSTRACT

A drill cuttings dryer that includes a centrifuge especially adapted to process drill cuttings; a torque converter in communication with the centrifuge; a motor; and, a drive shaft in communication with both and linking the motor and torque converter. A method of processing drill cuttings containing a liquid by introducing the drill cuttings to centrifuge, and then providing power from a motor to power the centrifuge and subject the drill cuttings to centrifugal force sufficient to remove at least some of the liquid from the drill cuttings, wherein the motor provides power to the centrifuge through a drive shaft. A method of retrofitting a drill cuttings dryer that utilizes a belt and sheave system, includes replacing the belt and sheave system with a drive shaft based system.

### RELATED APPLICATION DATA

Not applicable.

### BACKGROUND OF THE INVENTION

1. Field of the Invention

The present invention relates to methods of and apparatus for processing drill cuttings, and to methods of retrofitting drill cuttings dryers. In another aspect, the present invention relates to methods of and apparatus for drying drill cuttings recovered from drilling fluids used for drilling hydrocarbon wells, and to methods of retrofitting drill cuttings dryers. In even another aspect, the present invention relates to a drill cutting dryer in which power to the dryer centrifuge is provided through a drive shaft, to methods of drying cuttings using such dryers, and to methods of retrofitting drill cuttings dryers dryer in which power to the dryer centrifuge is provided through a belt and sheave system. In still another aspect, the present invention relates to a drill cutting dryer and method for drying drill cuttings which can be categorized as Class I, Division 2, and to methods of retrofitting cuttings dryers categorized as Class I, Division 1 into retrofitted cuttings dryers categorized as Class I, Division 2.

2. Brief Description of the Related Art

There is an inherent problem with the typical drill cuttings dryer utilized in the oil and gas industry, and more particularly in the processing of drill cuttings.

The standard cuttings dryer utilized in the oil and gas industry is not designed for operation is a combustible dust environment. This is mainly because, while, the oil and gas environment is generally recognized as a “Class I” location in which flammable vapors & gases may be present, it is generally not recognized as a “Class II” location in which combustible dust may be found. And, to categorize further, while the oil and gas industry is further categorized to be a Class I “Division 1” environment in which ignitable concentrations of hazards exist under normal operation conditions and/or where hazards may be caused by maintenance or equipment failure, it is not recognized as being a “Division 2” environment in which ignitable concentrations of hazards are handled, processed or used, but which are normally in closed containers or closed systems from which they can only escape through accidental rupture or breakdown of such containers or systems.

Thus capital equipment in the oil and gas industry, including the standard cuttings dryer utilized in drying drill cuttings, is designed to Class I, Division 1 standards. However, by operating these dryers in the drying of drill cuttings, an ignitable concentration of drill cutting dust is created within the dryer itself that now presents a dangerous Division 2 danger, with the danger hidden away. This will now be explained in more detail, including by a discussion of the drilling process and some relevant standards.

In the drilling of a borehole in the construction of an oil or gas well, a drill bit is arranged on the end of a drill string, which is rotated to bore the borehole through a formation. A drilling fluid known as “drilling mud” is pumped through the drill string to the drill bit to lubricate the drill bit. The drilling mud is also used to carry the cuttings produced by the drill bit and other solids to the surface through an annulus formed between the drill string and the borehole. The density of the drilling mud is closely controlled to inhibit the borehole from collapse and to ensure that drilling is carried out optimally. The density of the drilling mud affects the rate of penetration of the drill bit. By adjusting the density of the drilling mud, the rate of penetration changes at the possible detriment of collapsing the borehole. The drilling mud may also carry lost circulation materials for sealing porous sections of the borehole. The acidity of the drilling mud may also be adjusted according to the type of formation strata being drilled through. The drilling mud contains inter alia expensive synthetic oil-based lubricants and it is normal therefore to recover and re-use the used drilling mud, but this requires inter alia the solids to be removed from the drilling mud. This is achieved by processing the drilling mud.

This need for solids control in drilling mud in hydrocarbon well drilling is well known in the prior art. Generally, at the top of the well, the solids-laden mud is introduced to a shale shaker, a device which typically has a series of screens arranged in tiered or flat disposition with respect to each other. The screens catch and remove solids from the mud as the mud passes through them. If drilled solids are not removed from the mud used during the drilling operation, recirculation of the drilled solids can create viscosity and gel problems in the mud, as well as increasing wear in mud pumps and other mechanical equipment used for drilling.

The resultant solids recovered by the shale shaker, known herein as “drill cuttings”, are typically comprised of bits of shale, sand, hard clays, or shell that may have been present in the borehole. The drill cuttings are often coated with or contain residual liquids such as drilling mud or other liquids that may have been present in the borehole. The drill cuttings and the residual liquids may contain hazardous environmental contaminants that will require treatment before their ultimate disposal.

It is not unusual that these drill cuttings contain up to 20% oil by weight. For environmental reasons, current legislation/regulations in many countries, only permits the dumping of cutting material which has far lower oil content. Thus, these cuttings with their residual liquid contaminants are typically conveyed to a dryer for removal of the residual liquids. Very commonly, the dryer utilized is a vertical cuttings dryer.

However, the inherent problem with the conventional vertical cuttings dryers utilized in the oil and gas industry, is that they are based on conventional designs that were born in the mining industry. The mining industry typically works with water-based applications in which the technology would “dewater” the solids (i.e. cold fines). Mining does not use oil-based muds and rarely has these types of systems operating in hazardous environments (i.e. around a drilling rig).

Vertical cutting dryers utilized in the oil and gas industry have historically relied on belt-driven sheaves. Though belt-driven systems are cost effective and relatively easy to implement, at a minimum they have represented a maintenance nuisance, at worst they represent a serious safety concern when improperly design and/or maintained.

Most belts available in the market today must meet the ISO 9563 standard for static conductivity. However, they are only required to meet the standard when new. As soon as the belts are in use, their antistatic properties dramatically decrease, sometimes dangerously so. However, the generation of a static electrical discharge is only one of the potential safety concerns; the generation of excessive heat when belts break or slip through overloading cannot be ignored.

Most belt-driven gear-box Operation and Maintenance manuals will include a number of warnings relative to the use of belts in potentially hazardous environments. One of the industry's most common gear box manufacturers have included the following warning, “[We] do not support the use of our belt drive in explosion proof or hazardous environments. While the belt may be non-sparking, the belt drive assembly does not have a safety to disengage the belt. In the event of an overload the belt can slip and generate excessive heat.” However, it is not just belt-driven gear box manufacturers that have issued this warning. One of the industry's most prolific suppliers of industrial belt-driven sheaves shares similar concerns, “Although [we] know of no explosion caused by static generated by a V-belt drive, we cannot accept responsibility beyond that of furnishing belts within the above described limits.”

Despite the evidence of a real safety concern and the volume of warnings that have been published, little reaction has mounted within the oil and gas industry, mainly because those of skill in the oil and gas industry do not recognize any danger from combustible dusts. Thus, these belt powered dryers remain the industry standard.

Outside of the oil and gas industry, the dangers of combustible dusts have been recognized for many years. While, powders, coal, and oil are normally quite stable in bulk form, when otherwise dispersed as a cloud they can form an explosive mixture. All that is then required for an explosion to occur is a direct ignition source, which could be a heat source, frictional spark or an electrostatic discharge.

Indeed there are long established standards issued by the National Fire Protection Association (NFPA), the Occupational Safety & Health Administration (OSHA), Explosive Atmospheres (ATEX) Directives in Europe, and other national and international bodies that address the issue. Whenever standards have been implemented and compliance observed, it is clear that dust explosions have been reduced or eliminated, but it is also clear that implementation is not universal. This has become more obvious with the growing number of vertical cuttings dryers and related waste management devices entering the market from new entrants and the declining level of preventative maintenance being dedicated.

As it applies to the O&G industry, the Occupational Safety and Health Administration (“OSHA”), National Fire Protection Association (“NFPA”) Publication 70, and the National Electric Code (“NEC”), define two categories of hazardous materials that have been designated as Class I or Class II. The Classes define the type of explosive or ignitable substances which are present in the atmosphere. Class I locations are those in which flammable vapors & gases may be present, whereas, Class II locations are those in which combustible dust may be found.

Each of these Classes is further subdivided into two Divisions 1 or 2, and each defines the likelihood of the hazardous material being present in a flammable concentration.

Division 1 locations are those in which ignitable concentrations of hazards exist under normal operation conditions and/or where hazards may be caused by maintenance or equipment failure.

Division 2 locations are those in which ignitable concentrations of hazards are handled, processed or used, but which are normally in closed containers or closed systems from which they can only escape through accidental rupture or breakdown of such containers or systems.

As discussed above, for most oil & gas drilling installations, the common standard for capital equipment is Class I—Division 1. The omission of Class II—Division 1 specifications is predominantly driven by the fact that oil & gas drilling operations are not known to generate combustible dusts. Thus, ignorance of those of skill in the oil and gas industry regarding combustible dusts is not surprising as they are naturally absent from the oil and gas industry operating environment.

In general, the hazards present, relative to belt-driven sheaves, is not new. A variety of oil-field products have used belts for decades; centrifuges and pumps are some of the most common. History tells us that the risk of igniting a fire from a static electrical discharge generated from these devices is extremely rare. However, waste management cuttings dryers in oil and gas operations present a new unrecognized risk when improperly designed, operated or maintained due to the presence of a potentially combustible dust atmosphere, and unfortunately this new unrecognized risk is contained within the dryer, out of sight and out of mind of those in the oil and gas industry.

By design, waste management cuttings dryers attempt to generate a dry solids discharge. When an optimized dryer system is capable of achieving a solids discharge, with a moisture content less than 3%, a high volume of dust can be generated. Though it is common for dryer installations to observe dust and oil mist (when treating oil-based cuttings) surrounding the dryer, the concentrations of these dusts and oil mist never reach a level that could be considered combustible or hazardous, thus lulling those in the oil and gas industry into complacency with the general “Class I Division 1” rating. However, it is what happens within the confines of the dryer that drives the concern. When the dryer is operating at peak performance, a confined cloud of dust and oil mist is generated within the dryer itself.

Yes, it is true that most vertical cuttings dryers encase anti-static belts and sheave systems within an enclosed “belt tunnel”, and that even contributes to this problem being hidden. This is done for both safety purposes and to maximize belt life by protect the sheaves and belts from being exposed to the solids discharge. By having a fully enclosed belt tunnel, any electro-static discharge or heat source would not be in direct contact with a potentially combustible dust environment.

From time-to-time, however, there occur vertical cuttings dryer field installations in which damage is caused to this belt tunnel or when the belt-tunnel and gear box access doors were completely removed. Though the belts and sheaves were still predominantly protected from the falling solids discharge, any static-electrical discharge or heat source generated from damaged belts are fully exposed to a potentially combustible atmosphere.

More concerning is the growing number of new entrants into the market, especially those that are being imported from “low-cost country” sources. In many cases, these new entrants have poorly designed or completely exposed belt and sheave systems that provide no barrier between potentially combustible oil mist or dust and a static-electrical discharge or excessive heat source. Further, many of these same products lack any indication that their belts meet the ISO 9563 certification requirements. This does not always generate from a poor design, but from the fact that the country of origin may not have defined safety standards and laws requiring such protections.

While there are a number of new belt technologies, belt-tensioning systems, and static-dissipation systems available in the market, none of these options improve the “operator experience.” These systems require constant maintenance and the exhausting effort required to periodically replace belts.

There are a number of patents and publications that relate to the drying of drill cuttings, the following of which are merely a few.

U.S. Pat. No. 6,009,959 issued to Dietzen on Jan. 4, 2000, an oil and gas well cuttings disposal system with continuous vacuum operation for sequentially filling disposal tanks, includes the steps of separating the drill cuttings from the well drilling fluid on the drilling platform so that the drilling fluids can be recycled into the well bore during drilling operations. The cuttings are then transmitted via gravity flow to a materials trough having an interior defined by sidewalls and a bottom portion. The drill cuttings are suctioned from the bottom portion of the trough interior with a suction line having an intake portion that is positioned at the materials trough bottom. Drill cuttings are transmitted via the suction line to a pair of hoppers that each have an interior. A vacuum is formed in sequence within the interior of each hopper using a blower that is in fluid communication with the hopper interiors. The two hoppers are positioned one above the other so that cuttings can be added to the first, upper hopper via the suction line and then fed by gravity to the second, lower hopper. A valving arrangement maintains vacuum within the interior of at least one hopper at all times. A conduit discharges from the lower hopper into a selected holding tank so that a number of holding tanks can be filled in sequential, continuous fashion. As one tank is filled, the conduit is directed to the next holding tank.

U.S. Pat. No. 6,170,580 issued to Reddoch on Jan. 9, 2001, a method and system for collecting, defluidizing and disposing of oil and gas well drill cuttings is disclosed including a system consisting primarily of a separation tank assembly, a vacuum pump assembly, a solids collection box and a liquids collection tank. The separating tank having an upper slurry chamber, for receiving cuttings via suction from a shaker screen trough via a suction line, and a lower liquid chamber having a strainer therein, for collecting liquids compressed from the drill cuttings. A helical conveyor screw is passed through the upper slurry chamber and the strainer located in the lower liquid chamber. An adjustable plug is provided to restrict the cuttings flow through the strainer discharge opening. When cutting are forced from the upper slurry chamber via the helical conveyor screw into the strainer against the preset tension of the adjustable plug, fluids are forced through the sides of the strainer into the lower liquid chamber where they are pumped out to a liquids collection tank. The defluidized cuttings are then expelled by forcing the plug open and gravity fed into a solids cutting box. The full cuttings boxes are then removed from the platform for disposal. Alternatively the cuttings may be discharged from the separator into an injection module for slurryfication and injection into the site well formation.

U.S. Pat. No. 6,763,605 issued to Reddoch on Jul. 20, 2004 a vertical, centrifugal separator used for drying drill cuttings prior to transport or further processing. The separator is adapted to receive scavenged heat from any source and is further adapted to include internal conveyers, thereby lowering the overall operating profile and providing increased cuttings retention time within a heated environment.

WO2009074815 published Jun. 18, 2009 by Martin discloses the removal of fluid from fluid-contaminated waste solids and a method and apparatus for analysing and detecting the amount of oil in a fluid-contaminated waste material. In particular, there is described the removal of oil from drill cuttings at an offshore rig, onshore treatment facility and other oily wastes such as refinery wastes and an improved method and apparatus for analysing and detecting the amount of oil in solid material (e.g. drill cuttings) from an offshore rig, onshore treatment facility and other oily wastes such as from refinery wastes.

U.S. Patent Publication No. 20100101991, published Apr. 29, 2010 by Billeaud discloses a method and apparatus for removing fluids, particularly entrained and/or adherent fluids, from drill cuttings created during the well drilling process. An apron assembly collects drill cuttings and deposits such cuttings on a central rotor having multiple distinct chambers. A first chamber is loaded with drill cuttings. The central rotor thereafter cycles to a second position wherein a pressure seal is formed around the loaded first chamber. An air knife or similar device is used to blast compressed gas at the cuttings in the sealed chamber and force the cuttings against a screen. Solid components of the cuttings remain in the sealed chamber, while liquid components pass through the screen and are collected using an auger assembly. Following such separation, the rotor is cycled again, allowing dried cuttings to empty from the first chamber. The process is repeated for each chamber of the rotor.

EP Patent Publication No. EP2481881, published Aug. 1, 2012 by James, discloses a vacuum assisted drill cuttings dryer and handling apparatus has a vacuum tank and an associated vacuum pump and motor configured for use with a high speed centrifugal dryer. Cuttings are drawn from the shaker of a drilling rig into the centrifugal dryer by means of a vacuum created in the centrifugal dryer by the vacuum tank and an associated vacuum pump and motor. The dryer is provided with sealable exit doors that may be opened and closed in sequence to allow removal of the cuttings even as cuttings are drawn in to the centrifugal dryer. A fluids collection chamber in communication with vacuum lines between the vacuum tank and centrifugal dryer collects fluids drawn from the centrifugal dryer.

U.S. Pat. No. 8,528,665, issued Jackson on Sep. 10, 2013, discloses a mobile drilling waste management system including a trailer having at least one centrifuge and a solids catch tank receiving solids separated from drilling fluid by one or more of the centrifuges. And a method of reclaiming drilling fluid including pumping drilling fluid contaminated with solids onto a trailer, separating the contaminant solids from the drilling fluid with at least one centrifuge located on the trailer, directing the contaminant solids to a solids catch tank located on the trailer, and pumping the drilling fluid off of the trailer.

U.S. Pat. No. 8,533,974 issued to Burnett on Sep. 17, 2013, relates to the reclamation of components of wellbore cuttings material, and discloses systems that are used for reclaiming components of wellbore cuttings material. In one illustrative embodiment, a system is disclosed that includes, among other things, a dryer that is adapted to receive a drill cuttings mixture that includes drilling fluid and cuttings material, the dryer being further adapted to treat the drill cuttings mixture by drying the cuttings material below a preselected moisture content level. The system also includes a moisture sensor that is adapted to sense a moisture content of the cuttings material after it is dried by the dryer, and a cuttings reinjection system that is adapted to reinject the dried cuttings material into a well bore. Additionally, the system includes a conveyor system that is adapted to convey the dried cuttings material to the cuttings reinjection system, wherein the conveyor system includes, among other things, a positive pressure pneumatic conveying apparatus.

U.S. Pat. No. 8,668,634, issued to Wick on Mar. 11, 2014, discloses methods for separating liquids, such as oils from solids, such as drill cuttings, apply a centrifuge to process a solids-enriched output of a fluids/solid separation device. The centrifuge may be a horizontal decanter-type centrifuge. The output may be heated. In example implementations the centrifuge has a bowl angle of four degrees or less and a low fluid depth of two inches or less. The fluids/solids separation device may comprise a shale shaker and/or a main centrifuge for example. The output material may have a relatively high initial solids content, such as 50% or more.

However, in spite of the above advancements, there exists a need in the art for drill cuttings dryers and methods of drying drill cuttings.

There also exits a need in the oil and gas industry for a cuttings dryer, and methods for drying drill cuttings that overcome the problems discussed above.

There even also exits a need in the oil and gas industry for a cuttings dryer, and methods for drying drill cuttings that eliminates the belt and sheave system for providing power from the motor to the centrifuge.

There still also exits a need in the oil and gas industry for a cuttings dryer, and methods for drying drill cuttings, that meet the standards of Class I, Division 2.

There yet also exists a need in the oil and gas industry for the retrofitting of cuttings dryers, and to retrofitted cuttings dryers.

These and other needs in the art will become apparent to those of skill in the art upon review of this specification, including its drawings and claims.

### SUMMARY OF THE INVENTION

It is an object of the present invention to provide for drill cuttings dryer, and methods of drying drill cuttings.

It is also an object of the present invention to provide for a cuttings dryer, and methods for drying drill cuttings that overcome the problems discussed above.

It is even also an object of the present invention to provide for a cuttings dryer, and methods for drying drill cuttings that eliminates the belt and sheave system for providing power from the motor to the centrifuge.

It is still also an object of the present invention to provide for a cuttings dryer, and methods for drying drill cuttings, that meet the standards of Class I, Division 2.

It is yet also an object of the present invention to provide for the retrofitting of cuttings dryers, and to retrofitted cuttings dryers.

These and other objects of the present invention will become apparent to those of skill in the art upon review of this specification, including its drawings and claims.

According to one non-limiting embodiment of the present invention there is provided a drill cuttings dryer. The dryer may include a centrifuge especially adapted to process drill cuttings. The dryer may also include a torque converter with a torque converter first end in communication with the centrifuge and having a torque converter second. The dryer may also include a motor. The dryer may also include a drive shaft having a drive shaft first end in communication with the motor and having a drive shaft second end in communication with the torque converter second end.

According to another non-limiting embodiment of the present invention, there is provided a method of processing drill cuttings containing a liquid. The method may includes introducing the drill cuttings to centrifuge. The method may also include providing power from a motor to power the centrifuge and subject the drill cuttings to centrifugal force sufficient to remove at least some of the liquid from the drill cuttings, wherein the motor provides power to the centrifuge through a drive shaft.

According to even another non-limiting embodiment of the present invention, there is provided a method of retrofitting a drill cuttings dryer and retrofitted cuttings dryers, wherein the dryer comprises a centrifuge adapted to process drill cuttings; a motor; and a power translation system between the motor and the centrifuge comprises a belt and sheave system. The method may include replacing the belt and sheave system with a drive shaft so that the translation system comprises the drive shaft.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is schematic of a common prior art cuttings dryer 10 that generally includes a high-speed vertical centrifuge 14 with the resultant drill cuttings recovered on screen assembly 17 before being dropped out from dryer 10. Also shown are motor mount 12, gear box 15, and belt tunnel 19 with the belts and sheaves contained within the belt tunnel 19.

FIG. 2 is a schematic of one non-limiting embodiment of the present invention showing cuttings dryer 20, showing high-speed centrifuge 14, screen assembly 17 upon which the drill cuttings are recovered, gearbox 15, direct drive system that includes drive shaft 22 contained within drive shaft housing 25, a torque converter 23 in communication with gear box 15, and C-face flange 21 holds motor 12 in position and in communication with drive shaft 22.

FIG. 3 which is a side view of cuttings dryer 20 of FIG. 2.

FIGS. 4-6 are various cutaway views of cuttings dryer 20 of FIG. 2.

### DETAILED DESCRIPTION OF THE INVENTION

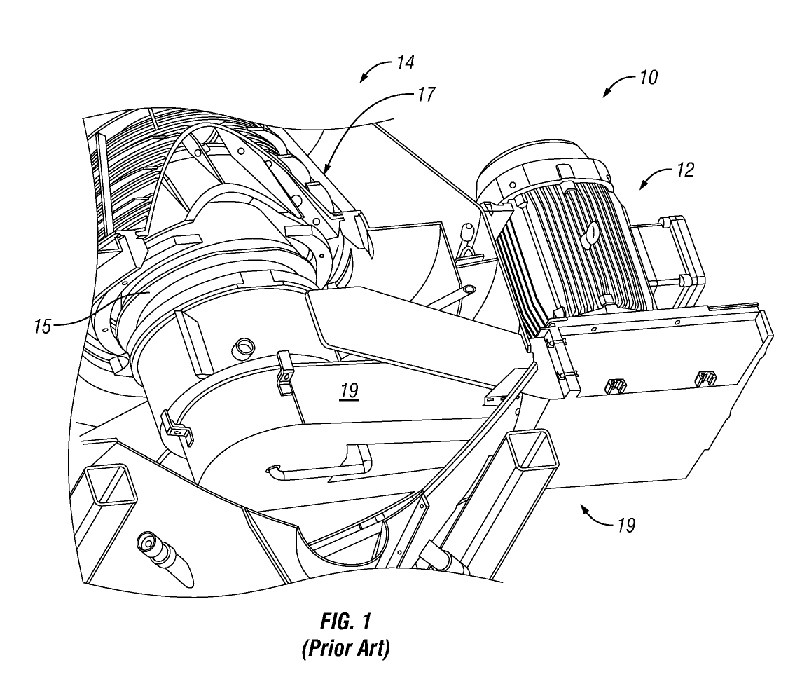

Prior to a discussion of the present invention, and in order to better understand how the present invention is an improvement over the prior art, reference will first be made to FIG. 1 showing a prior art cutting dryer commonly utilized in drying drill cuttings.

Referring first to FIG. 1, there is shown a schematic of a common prior art vertical cuttings dryer 10 that generally includes a high-speed vertical centrifuge 14 with the resultant drill cuttings recovered on screen assembly 17 before being dropped out from dryer 10. Other components of interest include motor mount 12, gear box 15, and belt tunnel 19 with the belts and sheaves contained within the belt tunnel 19.

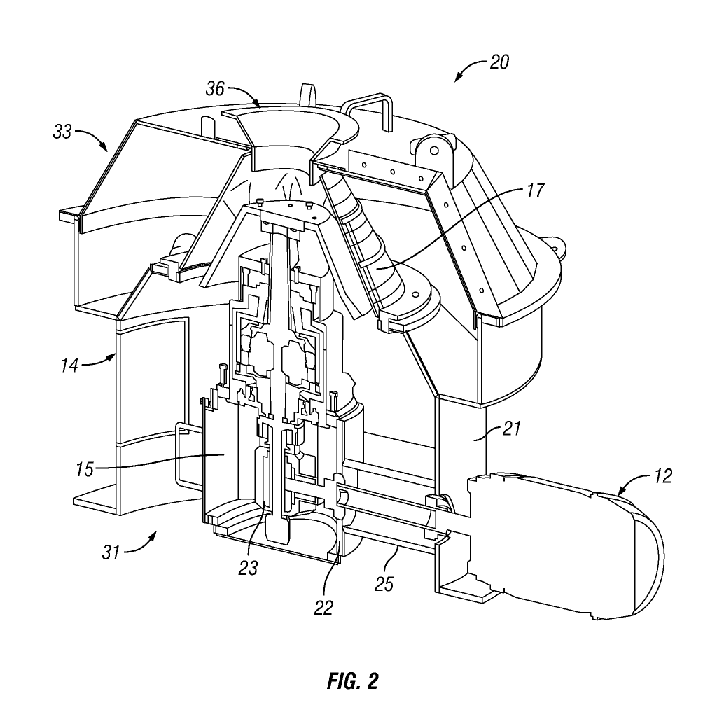

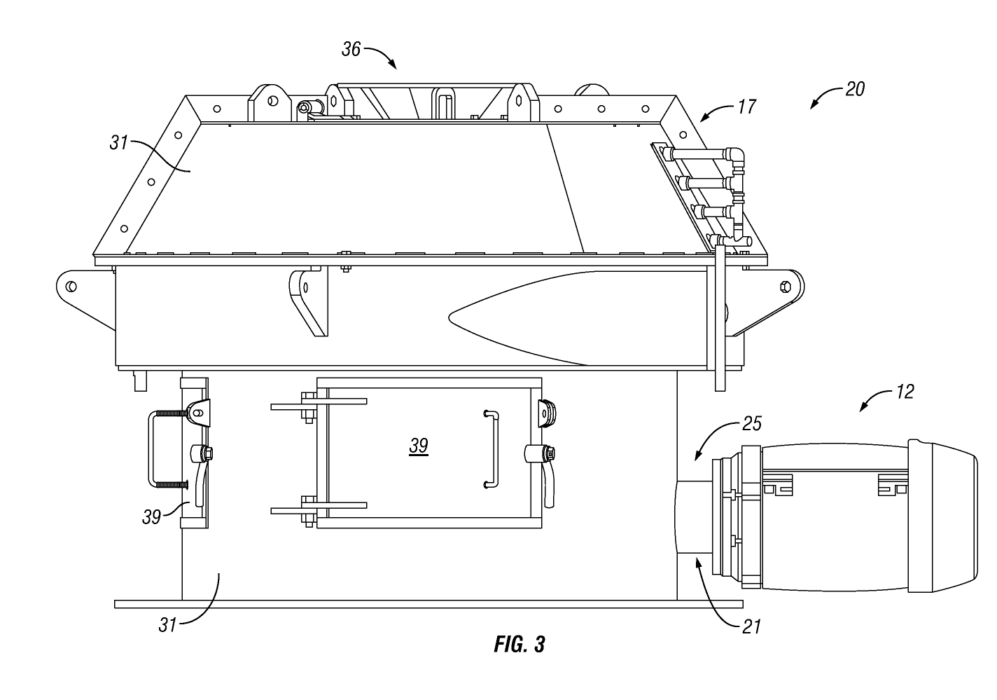

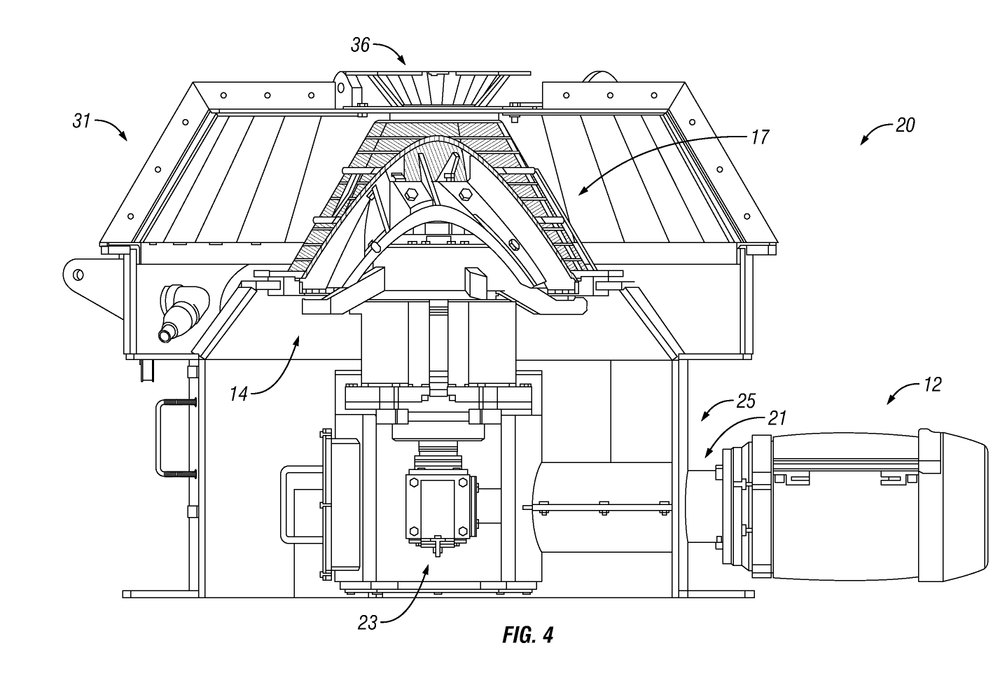

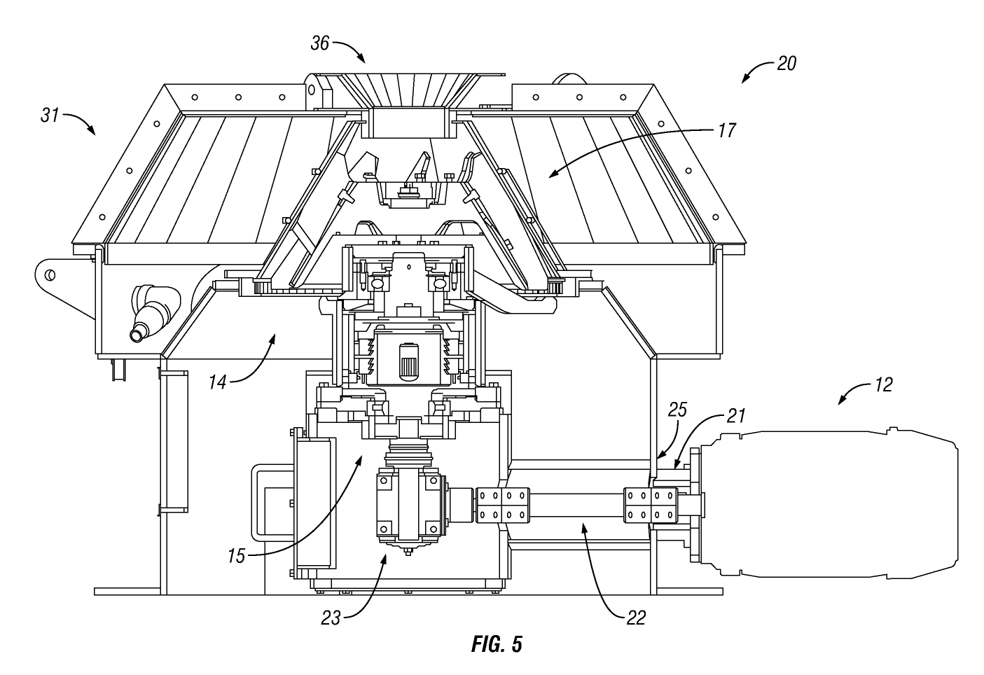

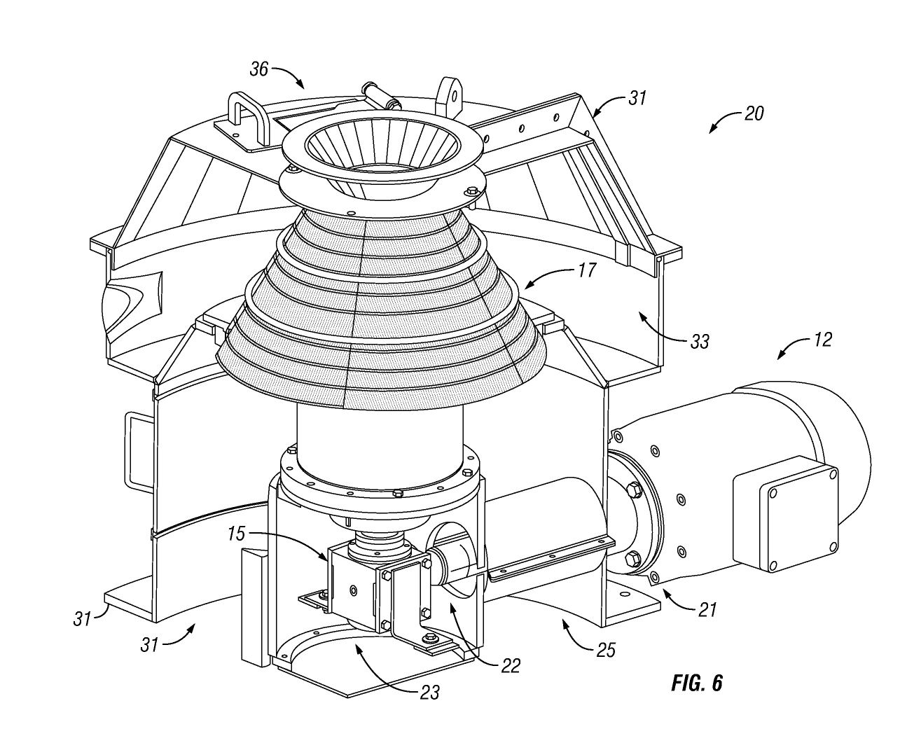

Referring now to FIG. 2 there is shown a schematic of one non-limiting embodiment of the present invention showing cuttings dryer 20. While it can be any type of cuttings dryer, cuttings dryer 20 is preferably a vertical cuttings dryer. Additional views are show in FIG. 3 which is a side view of cuttings dryer 20, and in FIGS. 4-6 which are various cutaway views of cuttings dryer 20. Cuttings dryer 20 may also include a dryer housing 31 and access doors 39. Like the prior art dryers, the non-limiting dryer embodiment as shown in FIGS. 2-6 includes a high-speed centrifuge 14, screen assembly 17 upon which the drill cuttings are recovered, and gearbox 15. Recovered solid drill cuttings are recovered at solids discharge 31 as shown, with liquids exiting at 33 as shown. In comparison to the prior art cuttings dryer, the belt and sheave system has been replaced with a direct drive system that includes drive shaft 22 contained within drive shaft housing 25, and a torque converter 23 in communication with the operating gear box 15. While a single 90 degree torque converter 23 is shown in the non-limiting embodiment, it should be understood that other embodiments with more torque converters (and perhaps drive shafts) or even no torque converter is contemplated. As non-limiting examples, directly coupling drive shaft 22 to the gearbox, or using multiple torque converters and maybe drive shafts. C-face flange 21 holds motor 12 in position and in communication with drive shaft 22. Material to be processed is introduced into dryer 20 through feed opening 36.

The drive shaft system will generally be configured to provide at least Category I, Division 2 compliance, and in many instances also Category I, Division 1 compliance.

Some non-limiting embodiments of the present invention provide drill cuttings dryers that completely eliminate the use of belts and sheaves between the motor and the centrifuge, and/or eliminate the need to enter the body of the dryer for maintenance of the drive system, as well as providing methods of drying drill cuttings utilizing such dryers.

Some non-limiting embodiments of the present invention provide for drill cuttings dryers that may incorporate any or all of an alignment compensating drive shaft, greased-for-life 90 degree torque inverter, and the a gear-box drive system, as well as providing methods of drying drill cuttings utilizing such dryers. Not only do various non-limiting embodiments of the present invention eliminate the need to enter the dryer to service and maintain drive belts, but they provide compliance with the current Class I—Division 1 and Class I—Division 2 categories.

Some non-limiting embodiments of the present invention provide for methods of retrofitting cuttings dryers categorized as Class I, Division 1 into retrofitted cuttings dryers categorized as Class I, Division 2. In general, the retrofitted cuttings dryers utilize a belt and sheave system to translate power from the motor to the centrifuge, with the belt and sheave system enclosed in a belt tunnel. In the method of retrofitting, the belt and sheave system and belt tunnel are replaced with a drive shaft system that may include 1 or more drive shafts. The drive shaft may be connected directly from the motor to the centrifuge (or the gearbox for the centrifuge) or may be include one or more torque converters between the motor and centrifuge (or the gearbox for the centrifuge). Most simply, as described above, a drive shaft is coupled with a 90 degree torque converter.

All of the patents, publications, applications, articles, books, magazines, and any other prior art cited in this specification, are herein incorporated by reference.

It should be understood that while the present invention has been illustrated mainly by reference to filtration of a gas stream, it finds utility in the filtration of gas streams, liquid streams, and gas/liquid streams.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A drill cuttings dryer comprising:
a centrifuge adapted to process drill cuttings;
a torque converter with a torque converter first end in communication with the centrifuge and having a torque converter second end;
a motor; and,
a drive shaft having a drive shaft first end in communication with the motor and having a drive shaft second end in communication with the torque converter second end.

2. The dryer of claim 1, wherein the converter is a 90 degree torque converter.

3. A method of processing drill cuttings containing a liquid:
introducing the drill cuttings to a centrifuge;
providing power from a motor to power the centrifuge and subject the drill cuttings to centrifugal force sufficient to remove at least some of the liquid from the drill cuttings, wherein the motor provides power to the centrifuge through a drive shaft.

4. A method of retrofitting a drill cuttings dryer, wherein the dryer comprises a centrifuge adapted to process drill cuttings; a motor; and a power translation system between the motor and the centrifuge comprises a belt and sheave system, the method comprises:
replacing the belt and sheave system with a drive shaft so that the translation system comprises the drive shaft.
